(19) United States
(12) Patent Application Publication
(10) Pub. No.: US 2019/0154079 A1
(43) Pub. Date: May 23, 2019

(54) Geodesic Framework Hub with Strut Holding Mechanism Movable Between Full-Hold and Partial-Hold Positions

(71) Applicant: Robert Shapiro, Winnipeg (CA)

(72) Inventor: Robert Shapiro, Winnipeg (CA)

(21) Appl. No.: 15/819,882

(22) Filed: Nov. 21, 2017

(51) Int. Cl. F16C 11/06; F16B 7/00

(52) U.S. Cl. CPC F16C 11/0695; F16C 11/0623; F16B 7/00

(57) ABSTRACT

A hub for interconnecting a plurality struts at a node of geodesic framework features a receiver and a holding mechanism. The receiver has a plurality of receptacles to each receive an end of a respective strut. The holding mechanism is movable between a full-hold position and different partial-hold positions. The full-hold position at least partially obstructs each of the receptacles to block withdrawal of any strut ends already received in the receptacles. Each partial-hold position reveals one of the receptacles to enable insertion or withdrawal of a strut end, while continuing to obstruct all of the other receptacles to prevent inadvertent separation of any previously installed strut. Struts are inserted one-by-one as the holding mechanism is indexed from one partial-hold position to the next, without worry of any preceding strut separating from the hub. A kit with a spacer enables fastening of two hubs together in a multi-layer geodesic framework.

### FIELD OF THE INVENTION

The present invention relates generally to hubs for assembling struts during erection of a geodesic framework, and more particularly to a hub with rounded receptacles for establishing ball and socket connections with ball-tipped struts.

### BACKGROUND

Use of a hub to join a plurality of struts together at each node of a framework is well known in the art. Among the known type of hubs are included hubs that employ ball and socket joints or universal joints at the connections between the hub and the struts.

For example, German Patent DE2815243 discloses a hub comprised of two plates whose facing-together inner sides have shallow rounded recesses therein in which ball-tipped ends of the struts are received so that clamping together of the two plates by a threaded fastener holds the balls securely between the plates, thereby securing the struts to the hub.

More recently, Build with Hubs Ltd. in the U.K. have developed another ball-and-socket based hub design where ball-tipped ends of the struts are snap-fit into rounded cavities arrayed around a plastic 3D printed or injection molded hub. The initial snap-fit placement holds the struts in place until a locking plate is subsequently bolted to the hub to more securely retain the struts in the fully assembled state of the framework. While the snap-fit function of the design improves the ease of assembly, the plastic material used to achieve such snap fit connections may limit the product to small-scale applications not subjected to significant loading.

Accordingly, there remains room for improvement in geodesic hub design.

### SUMMARY OF THE INVENTION

According to a first aspect of the invention, there is provided a hub for interconnecting a plurality struts at a node of geodesic framework, said hub comprising:

a receiver comprising a plurality of receptacles each arranged to selectively receive an end of a respective one of the plurality of struts; and

a holding mechanism operable between a full-hold condition at least partially obstructing each of the receptacles to block withdrawal of the ends of the plurality of struts from said receptacles when received therein, and any selected one of a plurality of partial-hold conditions, each of which reveals a greater area of a respective one of the receptacles than in the full-hold condition so as to enable insertion or withdrawal of the end of a respective one of struts to or from said respective one of the receptacles, while at least partially obstructing all of the other receptacles to prevent inadvertent separation of any strut ends received therein.

Preferably the holding mechanism is rotatable relative to the receiver.

Preferably the holding mechanism is shaped to at least partially obstruct each of the receptacles in the full-hold position and to reveal a greater area of the respective one of the receptacles under rotation of the holding mechanism into the any selected one of the partial-hold conditions.

Preferably said receiver has opposing inner and outer sides through which a central axis passes, and a peripheral edge that joins said inner and outer sides together around said central axis at a distance radially outward therefrom, and the receptacles comprise plurality of cavities recessed into the inner side of the receiver at circumferentially spaced positions around the central axis, and the holding mechanism comprises a cover cap fastened or fastenable to the receiver at the inner side thereof to overlie the cavities at said inner side of the receiver.

Preferably the cover cap is rotatable relative to the receiver, and the cover cap comprises a peripheral shape configured to at least partially obstruct each of the cavities in the full-hold position and to reveal more of the respective one of the cavities under rotation of the cover cap member into said any selected one of the partial-hold conditions.

Preferably the shape of the holding mechanism comprises one notched area selectively movable into alignment over the respective one of the receptacles in said any selected one of the plurality of partial-hold conditions.

Preferably each receptacle is a rounded cavity for receiving a ball-tipped end of the respective one of the plurality of struts, and the notch is arcuately shaped to generally conform to a curvature of the rounded cavity when the notch is aligned thereover.

Preferably the receiver comprises a plurality of open mouths each opening into a respective one of the cavities through the peripheral edge of the receiver, each mouth having a lesser width than the respective one of the cavities to block withdrawal of an enlarged tip at the end of the respective one of the struts through said mouth when said enlarged tip is received in said respective one of the cavities.

Preferably the holding mechanism is rotatable relative to the receiver about a same axis around which the receptacles are arrayed.

Preferably the receiver comprises a threaded feature around which the receptacles are arrayed for mating with a threaded fastener by which the holding mechanism is tightenable against the receiver to maintain the full-hold condition.

Preferably the threaded feature is a threaded bore in the receiver.

Preferably a depth of each cavity measured from the inner side of the receiver exceeds a thickness of the end of said one of the plurality of struts, and the inner side of the cover cap is flat.

According to a second aspect of the invention, there is provided a hub for interconnecting a plurality ball-tipped struts at a node of geodesic framework, said hub comprising:

a receiver having opposing inner and outer sides through which a central axis passes, and a peripheral edge joining said inner and outer sides together around said central axis at a distance radially outward therefrom;

a plurality of rounded cavities recessed into the inner side of the receiver at circumferentially spaced positions around the central axis to receive ball-tipped ends of the plurality of the struts;

a plurality of open mouths each opening into a respective one of the rounded cavities through the peripheral edge of the receiver, each mouth having a width measuring less than a diameter of the respective one of the rounded cavities; and

a cover cap fastened or fastenable to the receiver at the inner side thereof and rotatable between a full-hold condition at least partially obstructing each of the rounded cavities at the inner side of the receiver to block withdrawal of the ball-tipped ends of the plurality of struts when received in said rounded cavities, and any selected one of a plurality of partial-hold conditions, in each of which a respective one of the rounded cavities is more revealed at the inner side of the receiver than in the full-hold condition so as to enable insertion or withdrawal of a respective one of said ball-tipped ends of the struts to or from said respective one of the rounded cavities at the inner side of the receiver, while every other rounded cavity is at least partially obstructed by the cover cap at the inner side of the receiver to prevent inadvertent separation of any ball-tipped strut end received therein.

According to a third aspect of the invention, there is provided a method of assembling a plurality of struts to a hub during assembly of a geodesic framework, said method comprising, after inserting an end of a first strut into a first receptacle of the hub, and with a holding mechanism of said hub in a partial-hold position revealing a second receptacle of the hub while obstructing all other receptacles of said hub, (a) inserting an end of a second strut into said revealed second receptacle, then (b) repeatedly moving the holding mechanism to a subsequent partial-hold position revealing a subsequent receptacle of the hub while obstructing all other receptacles thereof, and inserting an end of next strut into said subsequent receptacle, until all receptacles have received an end of a respective strut, and then (c) moving the holding mechanism into a full-hold position obstructing all of the receptacles to prevent withdrawal of the struts therefrom,

Preferably the step of moving the holding mechanism in steps (b) and (c) comprises rotating a rotatable cap relative to the receiver of the hub in which the receptacles are defined so as to change which receptacles are obstructed by said rotatable cap.

According to a fourth aspect of the invention, there is provided an assembly kit for assembling a multi-layer node in a multi-layer geodesic framework, said kit comprising:

a first hub comprising a first receiver with a first bore therein and a first plurality of receptacles arrayed around said first bore for receiving respective ends of a first plurality of struts within said first plurality of receptacles;

a second hub comprising a second receiver having a second bore therein and a second plurality of receptacles arrayed around said second bore for receiving respective ends of a second plurality of struts within said second plurality of receptacles; and

a spacer fastenable to said first and second hubs within or through each of said first and second bores to hold said first and second hubs at an axial distance from one another and thereby hold set first and second plurality of struts in spaced relation to one another in different layers of the multi-layer geodesic framework.

Preferably said spacer has a male end received or receivable in one of the first and second bores.

Preferably said spacer has an opposing female end that is aligned or alignable with the other of the first and second bores for mating of said female end of the spacer with a male fastener through said other of the first and second bores.

Preferably the first hub comprises a first rotatable cap situated on a side of the first receiver facing away from the second hub, wherein the first bore is threaded and the kit comprises a first threaded fastener that passes or is passable through a central hole in a rotatable cover cap of the first hub for threaded mating with the first bore to clamp the first rotatable cap to the receiver and thereby lock said first rotatable cap against rotation.

Preferably the second hub comprises a respective rotatable cap situated on a side of the respective receiver facing toward the first hub, and the kit comprises a respective threaded fastener that passes or is passable through a central hole in the respective rotatable cap and threadingly mates with the spacer to clamp the respective rotatable cap to the respective receiver and thereby lock said respective rotatable cap against rotation.

Preferably at least one of the first and second bores is countersunk or counterbored at an end thereof for receipt of a respective fastener in said one of the bores in a position flush with or recessed from an exterior of the first or second receiver.

### BRIEF DESCRIPTION OF THE DRAWINGS

One embodiment of the invention will now be described in conjunction with the accompanying drawings in which:

FIG. 1 is a perspective of an assembled geodesic node as viewed from a capped side of a six-receptacle hub of the node, to which ball-tipped ends of six struts are held by a full-hold position of a rotatable cover cap that covers all six receptacles to prevent separation of any strut therefrom.

FIG. 2 is a perspective view of the assembled geodesic node of Figure from an opposing uncapped side of the hub.

FIGS. 3, 3A, 3B and 3C are perspective, plan, elevational and cross-sectional views of a receiver of the hub from an inner side thereof that is capped in FIG. 1.

FIGS. 4, 4A and 4B are perspective, plan and cross-sectional views of the cover cap from the node of FIG. 1.

FIG. 5 is a perspective view of one of the ball-tipped strut ends from FIGS. 1 and 2.

FIG. 6 is a perspective of another assembled geodesic node similar to that of FIG. 1, but featuring a five-receptacle hub to which five ball-tipped struts are connected.

FIG. 7 is a perspective of the receptacle and cover cap from the node of FIG. 1 with the cover cap rotated to a partial-hold position partially obstructing all but one of the receiver's six receptacles to enable insertion or removal of one strut to or from the one unobstructed receptacle.

FIG. 8 is an exploded perspective view illustrating assembly of two assembled geodesic nodes in a multi-layer geodesic framework.

FIG. 9 is an assembled perspective view of the two geodesic nodes of FIG. 8.

FIG. 10 is another assembled perspective view of the two geodesic nodes of FIG. 9 from an opposing side thereof.

### DETAILED DESCRIPTION

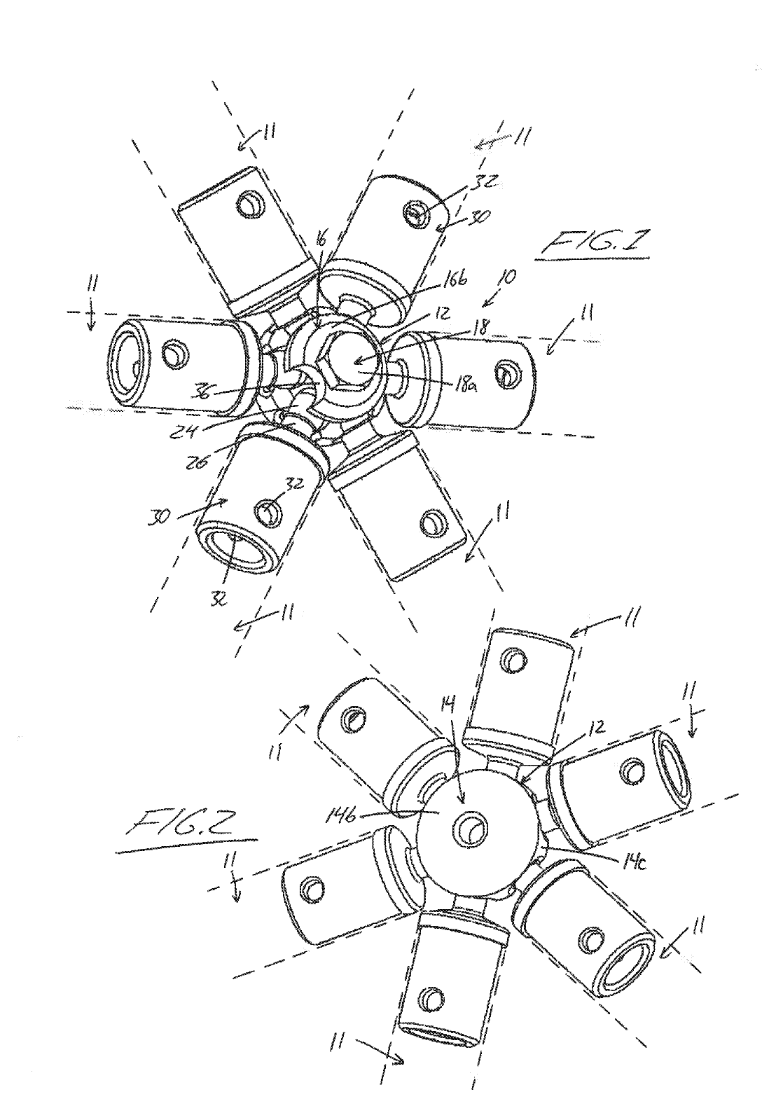

FIGS. 1 and 2 show an assembled node 10 of a geodesic framework.

The illustrated node features a three-piece hub 12 to which six struts 11 of the geodesic framework are connected. The three-pieces of the hub 12 include a receiver 14, a cover cap 16 and a threaded bolt fastener 18 securing the cover cap 16 to the receiver 14. The receiver in this instance defines six receptacles 20 for receiving the respective ball-tipped ends of the struts 11, and the cover cap 16 and fastener 18 serves as a holding mechanism for preventing separation of the struts 11 from the hub 12 as they are connected thereto one by one, and then also acts as a final locking mechanism to maintain the fully assembled state of the node once all struts 11 are connected. The receiver 14 features a generally disc-shaped or puck-shaped solid metal body having an inner side 14a and an opposing outer side 14b separated by an axial thickness of the solid body. The axial direction of the hub is denoted by a central axis A₁ passing centrally and orthogonally through the planes of the inner and outer sides. A peripheral edge 14c of the receiver's solid metal body joins the inner and outer sides together around the circular perimeters thereof at a radial distance outward from the central axis. The receptacles 20 are cavities recessed into the receiver's solid metal body from the inner side 14a thereof, and in the illustrated embodiment, are rounded cavities each bound by an arch-shaped wall when viewed in plan from the inner side of the receiver 14.

These cavities are uniformly spaced from one another in a circumferential direction around the central axis A₁. At the peripheral edge 14c of the receiver's solid metal body, a respective mouth 22 opens into each rounded cavity receptacle 20. The rounded shape of each cavity in plan view is that of a truncated circle whose area is greater than a semicircle, but less than a full circle. The circular shape is truncated by a truncation plane PT that lies parallel to and tangentially of the central axis A₁ at the mouth of the receptacle. Accordingly, in plan view from the inner side 14a of the receiver, the arcuate boundary wall 20a of each rounded cavity receptacle 20 spans more than 180-degrees from one side of the mouth 22 to other, and the width of the mouth W_{M} measured from one side to the other at the peripheral edge of the receiver body is less than the diameter D_{C} of the rounded cavity.

Turning to FIG. 5, the end of each strut 11 features a rounded ball 24 carried at the free end of a reduced cylindrical neck 26 of lesser diameter than the ball 24. The neck protrudes 26 protrudes from a capped end 28 of a cylindrical fitting 30 that mates with a respective end of the strut's main structural rod or tube, which is shown without detail in broken lines. In the illustrated example, a hollow end of the strut's main structural rod or tube fits externally over the cylindrical fitting 30, and the fitting 30 features a pair of aligned holes 32 situated diametrically across the fitting's hollow interior from one another to enable fastening of the main structural rod or tube to the end fitting 30 through these holes 32. However, it will be appreciated that the ball-tipped end fitting 30 may be attached to the main rod or tube in any number of different ways, whether removable or permanent.

The diameter D_{C} of each rounded cavity receptacle 20 in the receiver body slightly exceeds, but closely conforms to, the ball diameter D_{B} of each strut's ball tip 24. Meanwhile, the width W_{M} of each mouth 22 in the receiver body's peripheral edge 14c is less than the diameter D_{B} of each strut's rounded ball tip 24, and greater than the diameter of the cylindrical neck 26 of each strut's ball-tipped end fitting 30. Therefore, the ball tip 24 of each strut cannot fit through the mouth 22 of any receptacle 20, whereby the ball tip 24 of each strut is receivable in a selected one of the rounded cavities 20 only through the open top of the rounded cavity at the inner side 14a of the receiver body. This way, once the ball tip 24 of the strut is received in the selected receptacle 20, it cannot be withdrawn therefrom in the radial direction through the mouth 22 of the receptacle, as the narrow mouth 22 of the receptacle blocks radial withdrawal of the larger ball tip 24 out from rounded cavity. Meanwhile, the conforming rounded shapes of the strut's ball tip 24 and the receiver's rounded cavity 20 cooperate to define a ball and socket joint allowing the strut to occupy different angular orientations in its longitudinal reach outwardly from the hub to a neighbouring node, where the other end of the same strut features another ball-tipped end fitting 30 for mating with the hub of that neighbouring node.

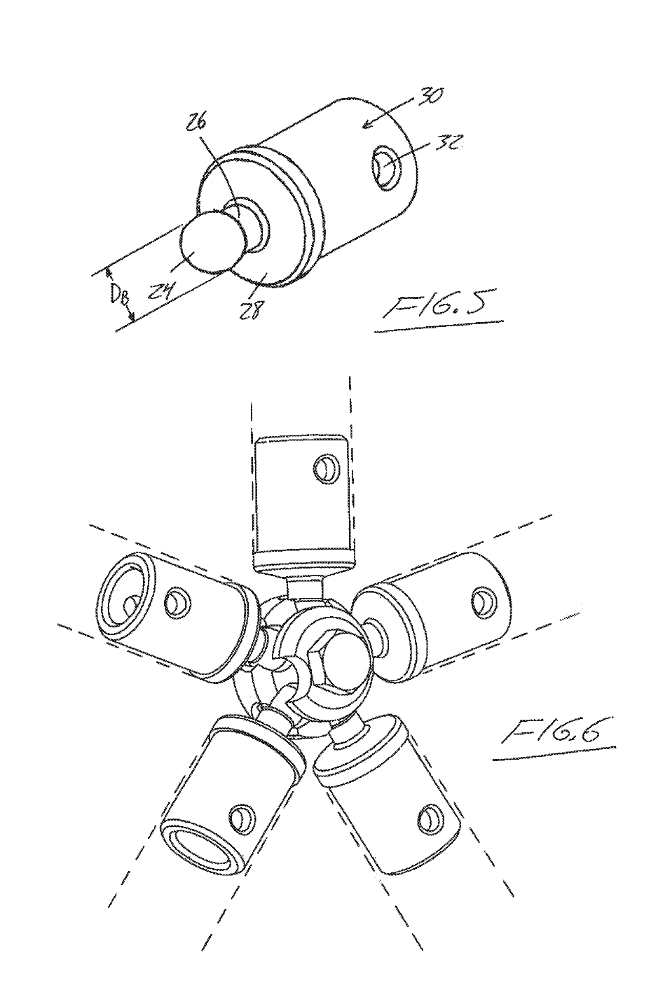

Turning now to FIG. 4, the cover cap 16 is a generally ring-shaped cap with a central through-hole 34 that penetrates axially through the cover cap on a central axis A₂ thereof to accommodate the threaded shaft of the bolt fastener 18. The bolt shaft reaches through the ring-shaped cap 16 into a threaded central bore 35 of the receiver 14 in order to fasten the cover cap 16 to the inner side 14a of the receiver 14 during assembly of the hub. Like the receiver, the cover cap 16 features an inner side 16a and an opposing outer side 16b separated therefrom by the axial thickness of the cap 16, as well as a peripheral edge 16c that joins the inner and our sides 16a, 16b together around their perimeters. The inner sides 14a, 16a of the receiver 14 and the cover cap 16 refer to the sides thereof that face together in the assembled state of the hub 12, while the outer sides 14b, 16b refer to those that face away from one another in the hub's assembled state.

The inner and outer sides of the cover cap 16 are flat, at least at center-adjacent areas thereof immediately surrounding the central through-hole 34. More specifically, the outer side 16b of the illustrated cover cap of has a flat center-adjacent area surrounding the central through-hole 34, and a chamfered or beveled area at the perimeter of the outer side 16b that joins up with the peripheral edge 16c of the receiver. Meanwhile, the inner side 16a is entirety flat over the full area thereof. The flat area of the outer side of the cover cap accommodates flush abutment thereof with the underside of the bolt head 18a when the bolt is tightened to clamp the cover cap 16 firmly against the inner side of the receiver 14. In the illustrated embodiment, the inner side 14a of the receiver 14 features a flat center-adjacent area surrounding the threaded bore 35 and reaching between the cavities 20, and a chamfered or beveled area at the perimeter of the inner side 14a that joins up with the peripheral edge 14c of the receiver 14. The rounded receptacles 20 of the receiver are deep enough to accommodate the full-diameter thickness of the strut ball tips 24 therein so that no part of the ball tip 24 reaches beyond the flat center-adjacent area of the receiver's inner side 14a. When the bolt 18 is loosened, this allows the flat inner side 16a of the cover cap to move freely over the ball-containing receptacles of the receiver 14 when the cover cap 16 is rotated around the shaft of the bolt fastener 18.

While the majority of the cover cap's circumference follows a circular path around the central through-hole 34 so that the peripheral edge 16c is substantially cylindrical in shape, a remaining minor portion of the cover cap's peripheral edge deviates from the round majority of the cover cap, and instead features an accurately contoured notch 36 jutting radially into the cover cap.

The radius of curvature of this notch 36 generally matches the radius of the arcuate wall 20a of each rounded receptacle 20 in the receiver 14. The arc-shape of the notch 36 is symmetrical across a radial plane P_{R2} that emanates radially outward from the central axis A₂ of the cap 16 in parallel relation thereto. Likewise, each rounded receptacle 20 of the receiver 14 is symmetrical across a respective radial plane P_{R1} that emanates radially outward from the central axis A₁ of the receiver 14 in parallel relation thereto. A radial distance measured from the central axis A₂ of the cap 16 to the notch 36 in the notch's plane of symmetry P_{R2} is equal to or slightly less than the radial distance measured from the central axis A₁ of the receiver 14 to any receptacle 20 in that receptacle's plane of symmetry P_{R1}. Accordingly, when the notch 36 is moved into a position aligning its plane of symmetry with that of one of the receptacles 20, the notch 36 closely conforms around the arc-shaped boundary wall 20a of that receptacle 20, thus revealing the entirety of the receptacle 20 at the inner side of the receiver 14 to enable insertion or withdrawal of a strut's ball tip 24 to or from that receptacle.

FIG. 1 shows the cover cap 16 in a full-holding condition where the notch 36 is not in alignment with any of the receptacles 20 of the receiver body. Instead, the notch 36 is misaligned between two adjacent receptacles 20 so as to span from a position overlying one of the adjacent receptacles to a position overlying the next receptacle. Since the notch's radius is comparable to the radius of any rounded cavity receptacle 20, it is too small to leave any two adjacent rounded cavities fully uncovered by the cover cap 16. So in this full-holding position, every single rounded cavity receptacle 20 of the receiver is at least partially obstructed by the cover cap 16 at the inner side 14a of the receiver 14. Tightening of the bolt fastener 18 clamps the cover cap 16 against the flattened center-adjacent area of the receiver's inner side, thereby locking the cover cap in this full-holding position obstructing all of the receptacles 20, whereby all of the ball tips 24 on the struts are blocked by the cover cap 16, and thus unable to escape the receptacles. So tightening of the bolt fastener 18 with the cover cap in the full-holding position securely locks all the struts 11 to the hub.

On the other hand, with the bolt fastener 18 in a loosened state, the cover cap 16 is rotatable around the central axis of the receiver 14 on the shaft of the loosened bolt 18. This allows rotation of the cover cap 16 into a partial-hold condition aligning the notch 36 over any selected one of the rounded receptacles 20, as shown in FIG. 7, thus fully opening up the selected receptacle at the inner side 14a of the receiver body 14 to enable insertion or removal of a strut's ball tip 24 to or from the selected receptacle. In the meantime, with only one notched-out area 36 provided in the cover cap's periphery 16c, all the other rounded receptacles 20 of the receiver 14 remain covered, thus preventing withdrawal of any of the other ball-tipped struts 11 from the receiver 14. The notched cover cap 16 rotatable about the bolt fastener 18 thus serves as a holding mechanism movable between a full-hold condition blocking all of the rounded cavities to prevent detachment of any and all struts, and a multitude of partial-hold conditions each opening up only a particular one of the receptacles to enable insertion or removal of a strut's ball tipped end thereto, while any other previously installed strut ends remain held to the hub to prevent inadvertent separation therefrom during this installation or removal of the current strut.

To assemble the node from scratch, the ball tip 24 of a first strut is inserted into an open receptacle of the receiver 14 from the inner side 14a thereof. This can be performed either with the cover cap 16 entirely removed from the receive body via removal of the bolt fastener 18, or with the cover cap 16 loosely fastened to the receiver body by the bolt fastener 18, but rotated into a first partial-hold position with the notch 36 aligned over the selected cavity for that first strut. Then, if not already installed, the cover cap 16 is loosely fastened to the receiver 14 with the bolt fastener 18, and the cover cap 16 is rotated into a subsequent second partial-hold position placing the notch 36 of the cover cap 16 in alignment over a second selected open cavity of the receiver 14. Here, the ball tip 24 of a second strut is inserted into the second selected open cavity of the receiver 14 through the aligned notch 36 in the cover cap 16. During this installation of the second strut, the first strut remains held to the receiver by the obstruction of the first cavity by the un-notched remainder of the cap cover's periphery. This process is then repeated by rotating the cap cover 16 to a third partial-hold position gaining access to a third selected cavity, where a third strut's ball tip 24 is inserted, followed by rotation to a fourth partial-hold position and insertion of a fourth strut, etc. until all six struts are received by the hub. At this stage, with the bolt fastener 18 still in a loosened state, the cover cap 16 is rotated one final time into the full-hold position misaligning the notch 36 between two adjacent cavities. The bolt fastener 18 is then tightened with a conventional wrench to lock the cover cap 16 in place, thus ensuring all struts remain securely held to the hub 12.

So, during installation of the second strut through to the final strut, each previously placed strut remains secured to the receiver due to the notched cover cap that closes all but one of the receptacles when the notch is aligned over that one receptacle. Since the installer need not worry about holding the ends of the previously inserted struts in place, notable ease of assembly is achieved. At the same time, using the cover cap as a built-in holding tool that prevents separation of the previously inserted struts, reliance need not be made on a temporary snap-fit between resiliently flexible plastic parts, whereby the receiver 14, cover cap, ball tips, end fittings and struts can all be made from strong, durable metal materials for optimal structural stability and longevity. In preferred embodiments, the receiver and cover cap may be made of steel, titanium, or other strong metals, whereby even large covered geodesic structures with high loading requirements may be constructed easily and quickly with the convenient strut-holding functionality of the unique hub design. Likewise, smaller geodesic structures with lower loading requirements may be assembled easily from the novel hubs, regardless of whether they are made of durable metals, or lower grade plastic materials selected as a more cost-efficient option for smaller scale applications.

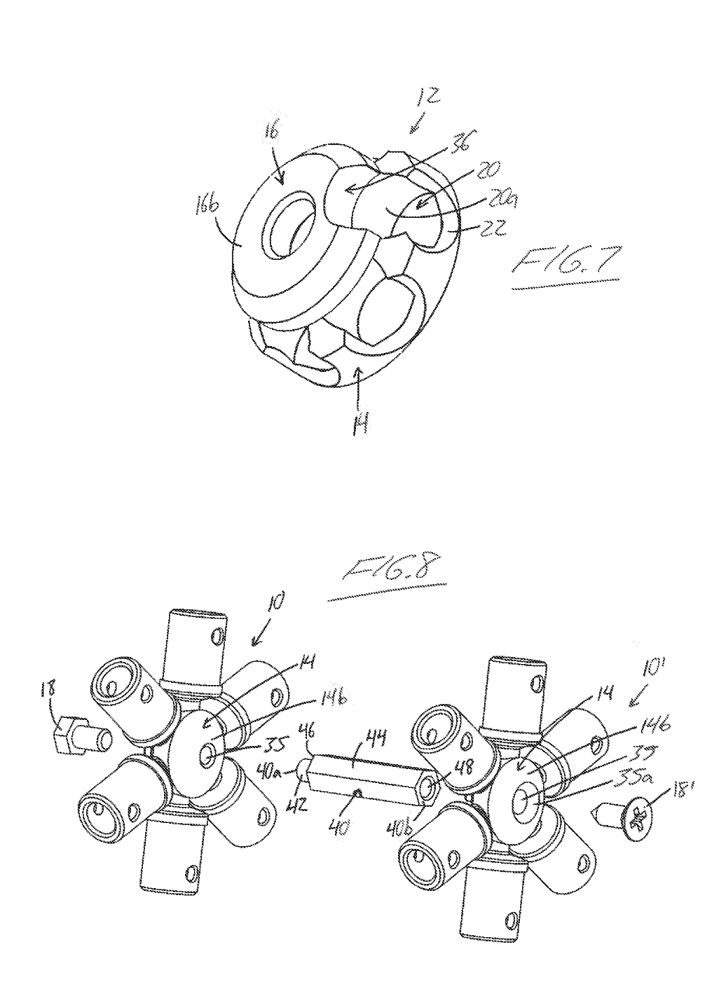

It will be appreciated that while the forgoing embodiment, describes a hub with six receptacles, the number may be varied. For example, FIG. 6 shows a five-strut node assembled from a hub with a five-receptacle receiver. Also, it will be appreciated that although the illustrated embodiment uses ball and socket joints between the hub and the struts, similar use of the cover cap to hold the inserted struts in place may be used regardless of whether the strut tips and receptacles are rounded to form ball and socket joints allowing angular flexibility in the assembly. The enlarged size of the terminal tip of the strut end relative to the reduced neck may similarly be used to prevent radial withdrawal of the strut tip through the peripherally located mouth of the receptacle regardless of whether the tip is a rounded ball tip, or any other shape. It will also be appreciated that the cover cap's periphery need not necessarily have a substantially round, single-notch configuration like that of the illustrated embodiment in order to cover all but one of the receptacles in the partial-hold position, and so other peripheral cap shapes capable of such function may alternatively be employed.

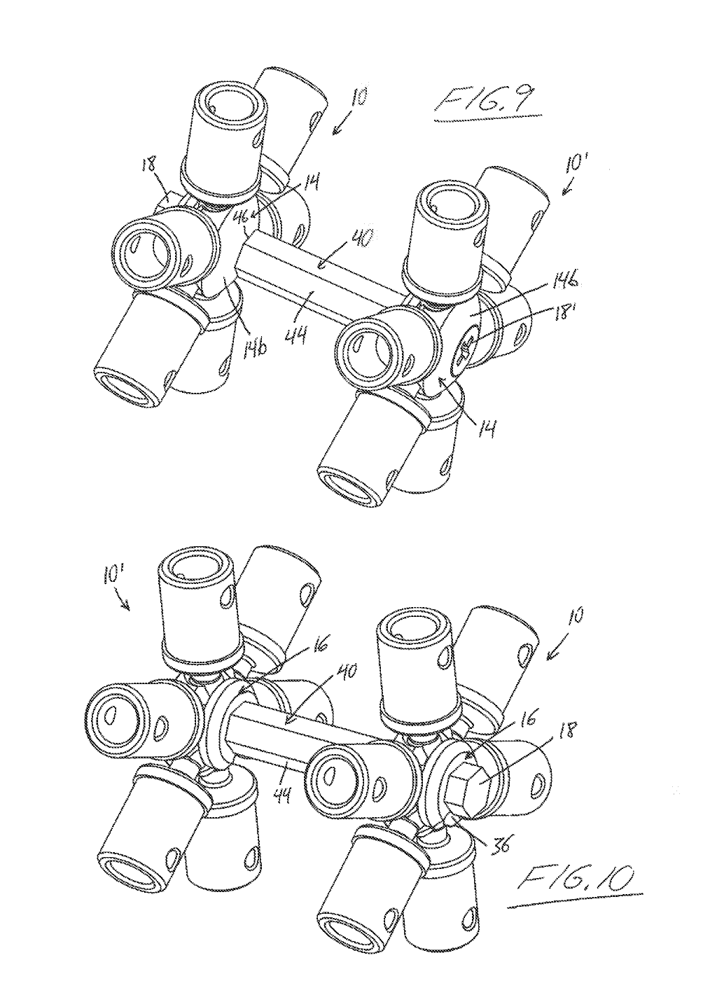

FIGS. 8 through 10 illustrate coupling of two nodes together as part of a multi-layer geodesic framework. In the illustrated two-layer example, first node 10 is found in a first inner layer of such framework, while second node 10′ is part of a second outer layer of the framework. One example of a geodesic structure that can be assembled in such a multi-layer manner is a two-layer dome where the inner framework defines a first inner dome of a first radial measure, and the outer framework defines a second outer dome of slightly greater radial measure that closes over the inner dome. Such multi-layer construction may improve overall load bearing capability of the geodesic structure, enable installation of insulation material between the layers of the framework, and/or have other advantages over a single-layer geodesic structure.

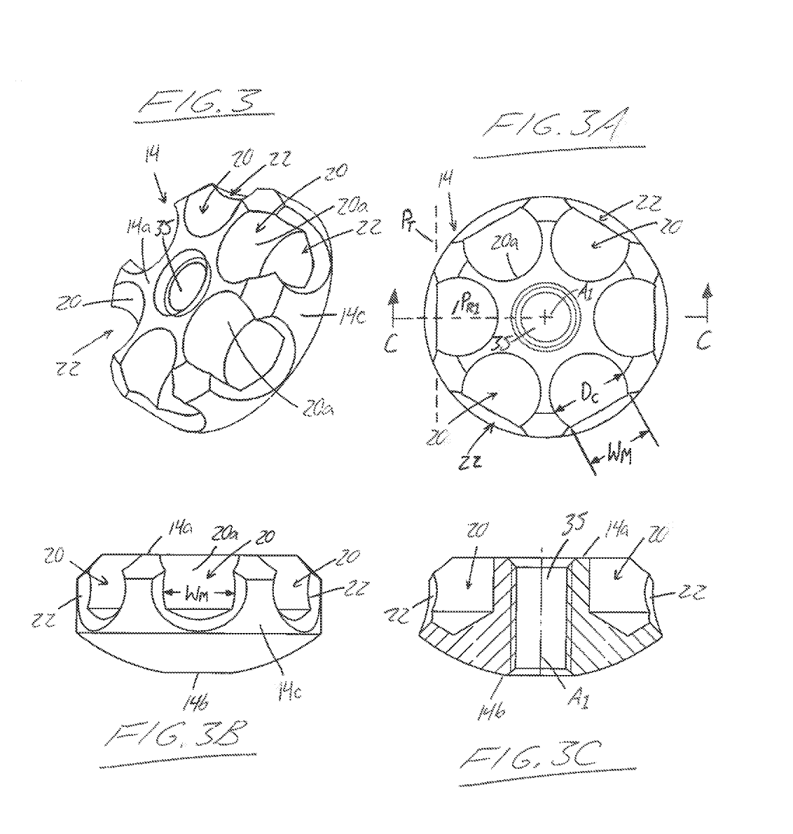

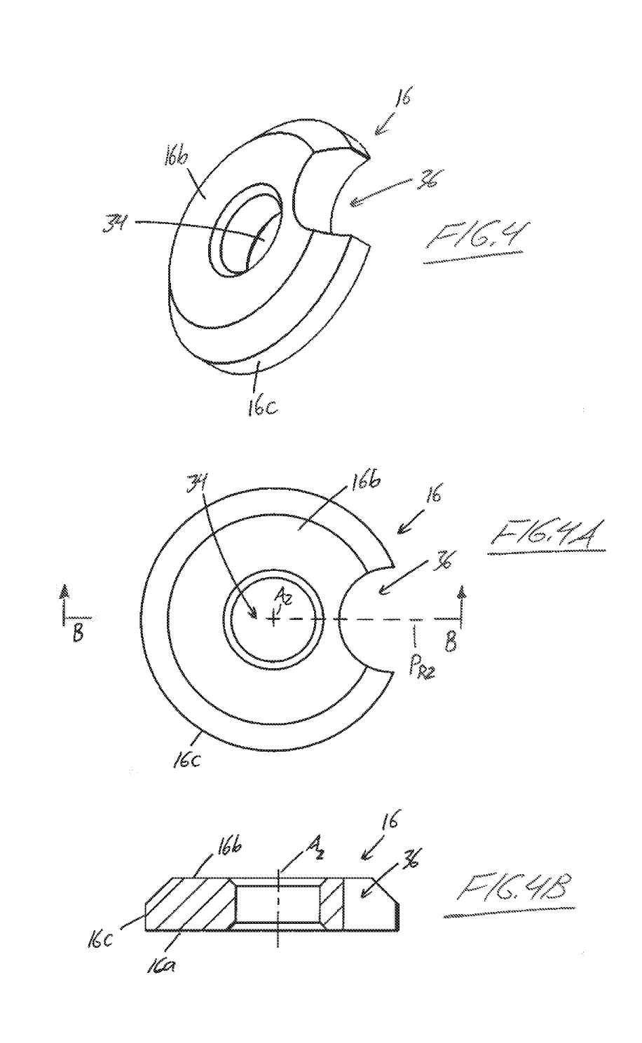

The first node 10 is of the same type described above in relation to FIGS. 1 through 5. The second node 10′ is of generally the same type, differing only in that the end of the threaded central bore 35 at the outer side of the receiver 14 is notably countersunk or counterbored, as shown at 35a. This counterbore or countersink enables flush or slightly recessed placement of the head of a threaded male fastener 18′ that is used to lock the cover cap of the second hub 10′ in its full-holding condition once the second node is fully assembled, and also to couple the second hub 10′ to the first hub 10.

To start construction of the multi-node assembly, the first node 10 is assembled first by connecting all of its struts to the receiver of its hub, and then locking the cover cap of the first hub in its full-holding position by engaging the bolt fastener 18 into the threaded bore 35 of the receiver via the central through-hole 34 of the hub's cover cap 16. An elongated spacer nut 40 has a male end 40a and an axially opposing female end 40b. The male end 40a features an externally threaded male pin 42 projecting axially from an externally hexagonal main body 44 of the spacer nut that spans the remainder thereof from the pin 42 of the male end 40a to the opposing female end 40b. The threaded pin 42 is of reduced diameter relative to the cross-sectionally larger hexagonal body 44, thus creating a shouldered transition 46 between the main body 44 and the pin 42. The threaded pin 42 of the male end 40a is threaded into the central bore 35 of the first node's receiver at the outer side thereof until the shoulder 46 of the spacer nut 40 abuts against the outer side of the first node's receiver. The female end 40b of the spacer nut features a threaded socket 48 that is recessed axially into the spacer nut 40 and is centered on the same central longitudinal axis thereof as the threaded pin 42 at the male end 40a. Fully threaded into the receiver of the first node hub, the spacer nut 40 is then ready for fastening of the second node thereto.

The struts of the second node 10′ are pre-assembled to the hub thereof in the same manner as the first node, but instead of feeding a bolt fastener 18 through the central hole 34 of the cover cap 16 to lock the cover cap in its full-holding condition in the final step of the node assembly, a second threaded male fastener 18′ is instead inserted through the central bore 35 of the second node's receiver from the outer side 14b of the receiver. This second male fastener 18′ reaches fully through the central bore 35 of the receiver 14 and onward through the central hole 34 of the second node's cover cap 16 into the threaded socket 48 at the female end 40b of the elongated spacer nut 40. Tightening of this second male fastener 18′ draws the female end 40b of the spacer nut 40 tight against the outer side 16b of the second node's cover cap 16, thus securely clamping this cover cap in its full-holding condition securing all the second node's struts to the second node's hub. Likewise, the tightened state of the second male fastener 18′ clamps the receiver 14 of the second node 10′ tight against the female end of the spacer nut 40. The second node 10′ is therefore now supported on the first node 10 at an axially spaced distance therefrom dictated by the spacer nut's axial measure from the shoulder 46 of the spacer nut to the female end 40b of the spacer nut.

In its fully tightened state, the head of the second male fastener 18′ is fully received in the counterbored or countersunk end 35a of the central bore 35 of the second node's receiver, as shown in FIG. 9. This way, the head of the second male fastener 18′ thus resides flush with, or partially recessed from, the outer side 14b of the second node's receiver 14. By having the first and second nodes placed in matching orientation so that their cover caps face in the same direction, the inner side of the second node's receiver faces toward the outer side 14b of the first node's receiver, while the outer side 14b of the second node's receiver thus faces away from the first node 10. Since the second node 10′ is part of the outer layer of the multi-layer geodesic framework, the outer side 14b of the second node's receiver resides at the exterior of the overall geodesic framework, where the flush or recessed placement of the second fastener's head thus avoids any protrusion reaching axially beyond the outer side 14b of the second node's receiver. The absence of a protruding bolt head, like that found at the inner side of the first node 10, avoids interference with placement of an external cover or cladding over the exterior of the geodesic framework.

The illustrated embodiment uses a countersunk screw as the second male fastener 18′ so that the head of the fastener has a conically tapered underside and a flat topside in which a drive pattern is recessed for mating with a matching drive tip of a screwdriver. The central bore in the receiver of the second node 10′ thus has a conically tapered countersink 35a that is fully occupied by the tapered screw head when the fastener is fully threaded into the receiver. The second fastener 18′ in another embodiment may instead be a bolt or machine screw whose head has a flat-underside, in which case the central bore in the receiver of the second node 10′ has an oversized counterbore of sufficient size to enable a socket to fit over the head of the second male fastener 18′ inside the counterbore.

Also, the illustrated embodiment uses a male-female spacer nut 40 having a threaded male tip at only one end, and a threaded hollow socket at the other end, whereby the spacer nut can be engaged to the first node 10 after the cover cap of the first node has already been locked in the full-holding position by the first bolt fastener 18. The benefit of having a female configuration at the opposing end is so that the second node 10′ is locked in its full-holding condition and fastened to the first node through the spacer by rotational drive of the second male fastener 18′ relative to the second node. This way, the assembled second node can be held still during this fastening of the two nodes together by the second male fastener 18′. Holding the second node static while rotationally driving the second male fastener 18′ is easier than having to rotate the second node 10′ in order to thread it onto a male end of a male-male spacer. However, other embodiments may employ such a male-male spacer, or alternatively a female-female spacer nut. In the case of a female-female spacer nut, the cover cap of the first node would not be locked solely by a first fastener threaded into the first node's receiver, but rather would be locked by threading of the first fastener 18 into one of the two female ends of the female-female spacer nut through the central bore of the first node's receiver.

Since various modifications can be made in my invention as herein above described, and many apparently widely different embodiments of same made, it is intended that all matter contained in the accompanying specification shall be interpreted as illustrative only and not in a limiting sense.

1. A hub for interconnecting a plurality struts at a node of geodesic framework, said hub comprising:
a receiver comprising a plurality of receptacles each arranged to selectively receive an end of a respective one of the plurality of struts; and
a holding mechanism operable between a full-hold condition at least partially obstructing each of the receptacles to block withdrawal of the ends of the plurality of struts from said receptacles when received therein, and any selected one of a plurality of partial-hold conditions, each of which reveals a greater area of a respective one of the receptacles than in the full-hold condition so as to enable insertion or withdrawal of the end of a respective one of struts to or from said respective one of the receptacles, while at least partially obstructing all of the other receptacles to prevent inadvertent separation of any strut ends received therein.

2. The hub of claim 1 wherein said receiver has opposing inner and outer sides through which a central axis passes, and a peripheral edge that joins said inner and outer sides together around said central axis at a distance radially outward therefrom, and the receptacles comprise plurality of cavities recessed into the inner side of the receiver at circumferentially spaced positions around the central axis, and the holding mechanism comprises a cover cap fastened or fastenable to the receiver at the inner side thereof to overlie the cavities at said inner side of the receiver.

3. The hub of claim 1 wherein the holding mechanism is rotatable relative to the receiver.

4. The hub of claim 3 wherein the holding mechanism is shaped to at least partially obstruct each of the receptacles in the full-hold position and to reveal a greater area of the respective one of the receptacles under rotation of the holding mechanism into the any selected one of the partial-hold conditions.

5. The hub of claim 2 wherein the cover cap is rotatable relative to the receiver, and the cover cap comprises a peripheral shape configured to at least partially obstruct each of the cavities in the full-hold position and to reveal more of the respective one of the cavities under rotation of the cover cap member into said any selected one of the partial-hold conditions.

6. The hub of claim 4 wherein the peripheral shape of the holding mechanism comprises one notched area selectively movable into alignment over the respective one of the receptacles in said any selected one of the plurality of partial-hold conditions.

7. The hub of claim 6 wherein each receptacle is a rounded cavity for receiving a ball-tipped end of the respective one of the plurality of struts, and the notch is arcuately shaped to generally conform to a curvature of the rounded cavity when the notch is aligned thereover.

8. The hub of claim 2 wherein the receiver comprises a plurality of open mouths each opening into a respective one of the cavities through the peripheral edge of the receiver, each mouth having a lesser width than the respective one of the cavities to block withdrawal of an enlarged tip at the end of the respective one of the struts through said mouth when said enlarged tip is received in said respective one of the cavities.

9. The hub of claim 3 wherein the receiver comprises a threaded feature for mating with a threaded fastener by which the holding mechanism is tightenable against the receiver to maintain the full-hold condition.

10. The hub of claim 9 wherein the threaded feature is a threaded bore in the receiver.

11. The hub of claim 2 in combination with at least one of the plurality of struts, wherein a depth of each cavity measured from the inner side of the receiver exceeds a thickness of the end of said one of the plurality of struts, and the inner side of the cover cap is flat.

12. A hub for interconnecting a plurality ball-tipped struts at a node of geodesic framework, said hub comprising:
a receiver having opposing inner and outer sides through which a central axis passes, and a peripheral edge joining said inner and outer sides together around said central axis at a distance radially outward therefrom;
a plurality of rounded cavities recessed into the inner side of the receiver at circumferentially spaced positions around the central axis to receive ball-tipped ends of the plurality of the struts;
a plurality of open mouths each opening into a respective one of the rounded cavities through the peripheral edge of the receiver, each mouth having a width measuring less than a diameter of the respective one of the rounded cavities; and
a cover cap fastened or fastenable to the receiver at the inner side thereof and rotatable between a full-hold condition at least partially obstructing each of the rounded cavities at the inner side of the receiver to block withdrawal of the ball-tipped ends of the plurality of struts when received in said rounded cavities, and any selected one of a plurality of partial-hold conditions, in each of which a respective one of the rounded cavities is more revealed at the inner side of the receiver than in the full-hold condition so as to enable insertion or withdrawal of a respective one of said ball-tipped ends of the struts to or from said respective one of the rounded cavities at the inner side of the receiver, while every other rounded cavity is at least partially obstructed by the cover cap at the inner side of the receiver to prevent inadvertent separation of any ball-tipped strut end received therein.

13. A method of assembling a node of a geodesic framework using the hub of claim 1, said method comprising, after inserting an end of a first strut into a first receptacle of the receiver, and with the holding mechanism of said hub in a partial-hold position revealing a second receptacle of the receiver while obstructing all other receptacles of said receiver, (a) inserting an end of a second strut into said revealed second receptacle, then (b) repeatedly moving the holding mechanism to a subsequent partial-hold position revealing a subsequent receptacle of the receiver while obstructing all other receptacles thereof, and inserting an end of a next strut into said subsequent receptacle, until all receptacles have received an end of a respective strut, and then (c) moving the holding mechanism into a full-hold position obstructing all of the receptacles to prevent withdrawal of the struts therefrom.

14. The method of claim 13 wherein moving the holding mechanism in steps (b) and (c) comprises rotating a rotatable cap relative to the receiver of the hub in which the receptacles are defined so as to change which receptacles are obstructed by said rotatable cap.

15. An assembly kit for assembling a multi-layer node in a multi-layer geodesic framework, said kit comprising:
a first hub comprising a first receiver with a first bore therein and a first plurality of receptacles arrayed around said first bore for receiving respective ends of a first plurality of struts within said first plurality of receptacles;
a second hub comprising a second receiver having a second bore therein and a second plurality of receptacles arrayed around said second bore for receiving respective ends of a second plurality of struts within said second plurality of receptacles; and
a spacer fastenable to said first and second hubs within or through each of said first and second bores to hold said first and second hubs at an axial distance from one another and thereby hold set first and second plurality of struts in spaced relation to one another in different layers of the multi-layer geodesic framework.

16. The kit of claim 15 wherein said spacer has a male end received or receivable in one of the first and second bores.

17. The kit of claim 16 wherein the kit further comprises a male fastener and said spacer has an opposing female end aligned or alignable with the other of the first and second bores for mating of said female end of the spacer with said male fastener through said other of the first and second bores.

18. The kit of claim 15 wherein the first hub comprises a first rotatable cap situated on a side of the first receiver facing away from the second hub, wherein the first bore is threaded and a first threaded fastener passes or is passable through a central hole in a rotatable cover cap of the first hub for threaded mating with the first bore to clamp the first rotatable cap to the receiver and thereby lock said first rotatable cap against rotation.

19. The kit of claim 15 wherein the second hub comprises a respective rotatable cap situated on a side of the respective receiver facing toward the first hub, wherein a respective threaded fastener passes or is passable through a central hole in the respective rotatable cap and threadingly mates with the spacer to clamp the respective rotatable cap to the respective receiver and thereby lock said respective rotatable cap against rotation.

20. The kit of claim 15 wherein at least one of the first and second bores is countersunk or counterbored at an end thereof for receipt of a respective fastener in said one of the bores in a position flush with or recessed from an exterior of the first or second receiver.
